(19) United States
(12) Patent Application Publication
(10) Pub. No.: US 2004/0243433 A1
(43) Pub. Date: Dec. 2, 2004

(54) System and method for management of patent data

(75) Inventors: Paul A. Akin, Plano, TX (US); Chase B. Finley, New Orleans, LA (US); Brian M. Jones, Plano, TX (US); Jose Alfonso Pena, McAllen, TX (US); Mike Wattenbarger, The Colony, TX (US); James G. Zoccoli, Carrollton, TX (US)

Correspondence Address: KENNETH R. GLASER, JAMES O. SKARSTEN, GARDERE WYNNE SEWELL LLP, 1601 ELM STREET, SUITE 3000, Dallas, TX, 75201-4767, US

(73) Assignee: LifeCare Management Services, L.L.C., Plano, TX (US)

(21) Appl. No.: 10/445,734

(22) Filed: May 27, 2003

(51) Int. Cl. G06F 17/60

(52) U.S. Cl. 705/2

(57) ABSTRACT

A computer system and method for use by a health care provider engaged in furnishing services to patients includes a pre-assessment component and a rate monitor. In pre-assessment, a specified characteristic of an incoming patient, such as clinical picture, diagnosis related group, or physician information, is compared with characteristics of previous patients. Previous patients matching the incoming patient in regard to the specified characteristic are selected for a group. Information pertaining to the patients of the group is then used to estimate the health care resources needed to treat the incoming patient. Pre-assessment further includes development of a reimbursement methodology and a budget for the incoming patient. The rate monitor maintains a database of the resources actually used in providing health care services to respective patients of the provider. The database can be accessed to provide real time data for use in adjusting or re-allocating resources subsequently furnished to patients.

### FIELD OF THE INVENTION

The present invention relates generally to the field of medical patient care, and specifically to a system and method for the management of data related to the treatment of a patient by a provider of health care services.

### BACKGROUND

The cost and complexity of providing health care is increasing at a rapid pace. With the increase in expense has come an appreciation for the need to control costs through the efficient management of the health care process, and in particular management of patient records.

Previous patient information record management has included the use of paper files for individual patients. While this method was useful, it made the compilation of data for comparison to the treatment of other patients with similar conditions difficult and time consuming. It also made it difficult to do quality control checks because the charts were physically located with the patient.

Attempts have been made to bring some order to the management of patient records. Many of these systems are simply computer files that have been transcribed from paper records. As such, they are prone to similar problems to those of paper records.

There is a need for an effective method by which the patient data may be input into a computer system in such a way that it can be compared with the records of other patients with similar medical conditions, so that the types of procedures and care that the patient may require can be evaluated, and the cost of such services estimated. Such a system should also preferably include a method for tracking the actually incurred costs for patient health care, and for making such information available whenever desired.

### SUMMARY OF THE INVENTION

The present invention provides a new and improved computer system and improved methods for the assessment and administration of health care services to an incoming patient that allow the health care professional to refer to the treatment histories of previous patients that presented similar medical conditions. Performing an assessment of the incoming patient in view of such previous patients allows the health care professional to determine the types of services and resources required to effectively treat the incoming patient. It also allows for the prediction of the cost of the services and more accurate creation of a budget for the treatment of the patient. Additionally, the present invention provides for tracking of charges the patient has actually incurred.

In one form the system of the present invention includes one or more databases connected to a data collection module. The data collection module is configured to collect, compare and store patient demographic information, clinical picture, insurance information and referral source information, independently, or in combination. A report generation module is in communication with one or more of the databases and configured to produce reports.

In another form, the present invention includes the steps of collecting incoming patient data and entering that data on one or more forms for placement in one or more of the databases. The data for the incoming patient is then compared to the data of one or more other patients treated for similar medical conditions, and generates a report with the predicted services.

In yet another form, the present invention utilizes a computer program on a computer readable medium for operating a computer processor to create an incoming patient record, compare the incoming patient record with records of previous patients, provide an estimate of resources to be used in treating the incoming patient, and at any time thereafter providing data in real time showing actually used resources.

### BRIEF DESCRIPTION OF THE FIGURES

For a complete understanding of the features and advantages of the present invention, reference is now made to the detailed description of the invention along with the accompanying drawings in which:

FIG. 1 is a schematic diagram pertaining to acquisition of incoming patient data for an embodiment of the invention.

FIG. 2 is a flow chart illustrating a pre-assessment procedure for an embodiment of the invention.

FIG. 3 is a schematic diagram showing a simplified computer circuit for use in the pre-assessment procedure of FIG. 2.

FIG. 4 is a flow chart illustrating a rate monitor for use with the pre-assessment procedure of FIG. 2 for an embodiment of the invention.

FIG. 5 is a schematic view showing a simplified computer system for implementing an embodiment of the invention.

### DETAILED DESCRIPTION OF THE INVENTION

In one embodiment of the present invention, directed to a computer system for use in a health care facility, there are two basic components, a pre-assessment routine or procedure and a rate-monitoring tool. The pre-assessment procedure allows a system user to perform an assessment of prospective or incoming patients before they are admitted to the facility. This is accomplished by initially acquiring information pertaining to an incoming patient, using an intake coordinator or the like. This information is then used to identify previous patients of the facility who had similar medical conditions, or were otherwise similar to the incoming patient. Data obtained from these previous patients can then be used to estimate the resources a patient will require once admitted, and the resources can be budgeted. The rate monitor, the second component of the inventive embodiment, enables the system user to monitor every patients' charges, costs and length-of-stay, at any time during or after their respective stays. This is achieved by extracting all of a patient's actual charges and other information from the health care facility accounting system, and then formatting it into useable data. Moreover, this data indicating the resources a patient is actually using or has used, is provided in real time. Accordingly, such real time data is readily available for making timely decisions to adjust delivery of health care services, and to thereby improve efficiency and effectiveness.

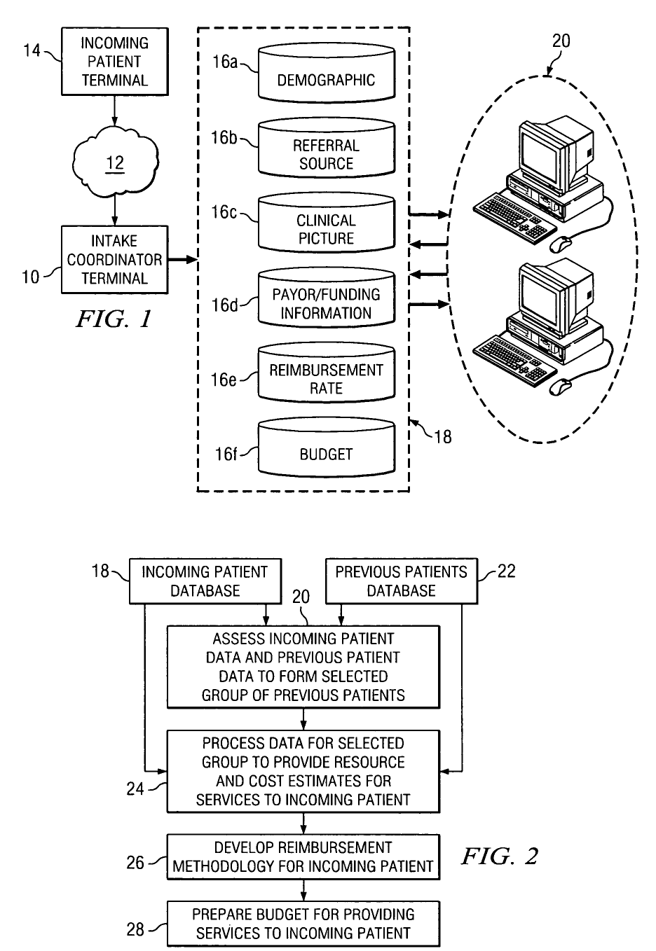

Referring to FIG. 1, there is shown an exemplary configuration for acquiring pertinent data from an incoming patient. In accordance therewith, an intake coordinator or other system user operates an intake coordinator terminal 10 to establish a communication path through a network 12 to the terminal 14 of an incoming patient. Terminals 10 and 14 could, for example, be telephone or computer terminals, and network 12 could be a telephone network or a computer network such as the Internet, or could be a combination of both. Patient data received at the intake coordinator terminal 10 may include, for example, demographic data 16a; referral source data 16b; a clinical picture of the patient 16c, as defined hereinafter; payor or funding information 16d, such as the name of the insurance provider; and a reimbursement rate 16e.

Referring further to FIG. 1, there is shown a database 18 disposed to store the incoming patient data. The data may then be readily accessed by terminals 20 of the health care provider's computer system, for use thereby as described hereinafter. Database 18 may also be used to store a budget 16f generated for treatment of the incoming patient, as likewise described hereinafter.

In order to carry out the pre-assessment procedure referred to above, it is necessary to select an incoming patient, in the event there is more than one patient waiting in queue for such procedure. In one embodiment, a user at a system terminal brings up a list of patients waiting to be pre-assessed. The user then selects a patient from the list, and information such as referral information and the clinical picture of the patient is displayed.

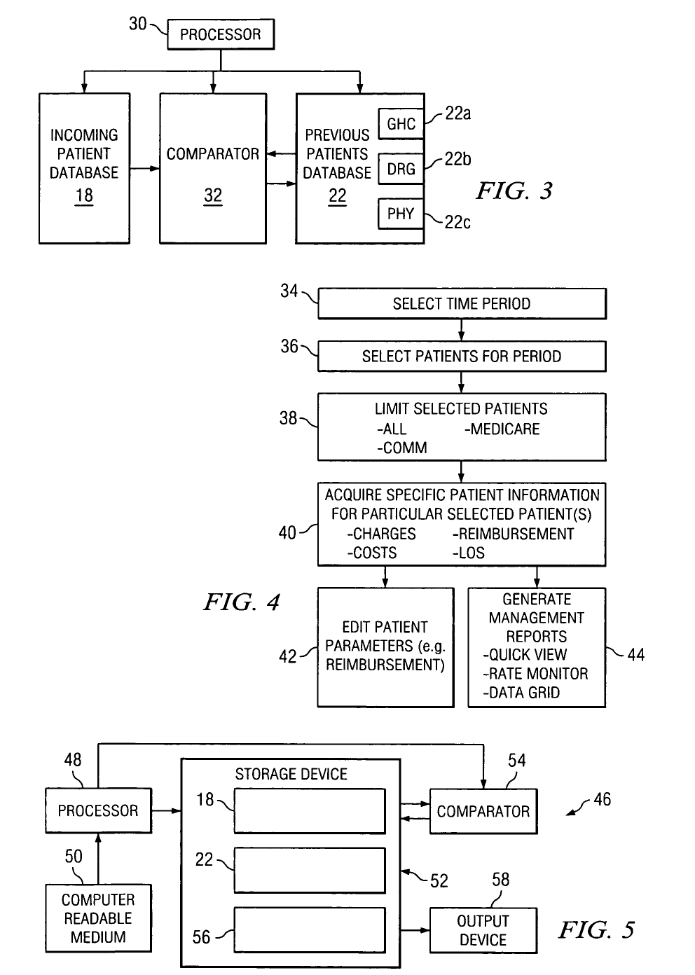

Referring to FIG. 2, there is shown a flow chart illustrating principal steps of the pre-assessment procedure. Function block 20 indicates that after an incoming patient has been selected, data pertaining to previously treated patients of the health care facility is assessed in view of, or compared with, incoming patient data from database 18. The data for the previous patients is supplied from a database 22, and includes some of the same types of data described above for the incoming patient. Data for previous patients may particularly include patient medical conditions, clinical pictures, diagnoses and/or physician information. The previous patient information is assessed at function block 20, in order to select a group of previous patients that all have one or more characteristics that are similar to those of the incoming patient. In one embodiment, several different types of characteristics can alternatively be used to select the group of previous patients, as described hereinafter in further detail in connection with FIG. 3.

Referring further to FIG. 2, there is shown function block 24 receiving information from the previous patients database 22. More particularly, after the group of previous patients has been selected, charge, cost and related data for all the patients in this group is provided to block 24. This data is then processed to provide estimates of the costs and resources needed to provide services to an incoming patient having a specified medical condition. More particularly, at function block 24 the selected group data is processed to provide average charge and cost data, as well as Reimbursement, Margin, and ALOS data, wherein ALOS is the Average Length of Stay for the previous patient group. The average charge and cost data indicates the average charges and average costs, respectively, for the patient group both daily and for the entire stay. The Reimbursement data is calculated by imputing a particular reimbursement methodology to the incoming patient. The system may be operated to compare the charge data to the calculated reimbursement, to indicate whether such reimbursement will cover the resources necessary to treat the incoming patient. Margin data indicates the difference between cost and reimbursement, both per day and for the entire stay.

In order to obtain more accurate cost and resource estimates, certain information from incoming patient database 18 is also directed to function block 24. For example, if the incoming patient would not need any operating room procedures, the charge and cost amounts could be reduced accordingly. This capability to adjust the cost average derived from the group, in view of specific needs of the incoming patient, provides great flexibility in pre-assessment.

The next step in the pre-assessment procedure, as shown by function block 26 of FIG. 2, is to build or develop a reimbursement methodology for the incoming patient. Reimbursement methodology, as used herein, generally refers to determining how the provider of health care will be reimbursed for its services and how payment will be calculated for specific types of charges. This task will be based upon either a pre-existing contract or negotiation efforts, as further described below.

Developing reimbursement methodology is comparatively simple if the incoming patient is within a preexisting health care network affiliated with the health care provider. Usefully, each contract that the provider has with a network is stored in a computer database. Then, it is only necessary to acquire information identifying the particular network of the incoming patient. The contract for such network can be readily accessed, loaded into the system computer, and thereafter referred to, in order to determine the specific reimbursement allowed for each charge in providing services to the incoming patient.

If the incoming patient is not within an affiliated network, that is, is “out of network”, it may be necessary for an operator or user of the system to negotiate a reimbursement methodology. The reimbursement could be based on per diem, per diem with pass-throughs, a percent of charges, or a combination thereof. The reimbursement building procedure is driven by revenue codes. Thus, negotiations cannot go below the revenue code level. Reimbursement negotiations may also be affected by special conditions, for example, the condition that rates include provider facility charges and exclude physician fees.

After providing a reimbursement methodology, a budget can be prepared for the incoming patient, as indicated by block 28 of FIG. 2. The budget will state an average daily cost and an average daily charge for each department, and thus provide a measure of what the patient should be getting charged and should cost each department each day. The budget is usefully retained in a computer system database. A user thereof can then be readily informed that the incoming patient will stay for a particular number of days at a particular cost per day, and that the health care facility will receive a known amount for its services and can anticipate a known profit or loss for the patient. If the incoming patient is admitted, the budget can also be used subsequently, to perform comparisons between budgeted and actual charges and cost. If desired a hard copy of the budget can be printed for reports and record keeping.

Referring to FIG. 3, there is shown a simplified circuit for carrying out the process of function block 20 of FIG. 2, that is, formation of the selected group of previous patients. One option, of course, would be to manually select previous patients, if a user is aware of a specific patient or patients that are similar to the incoming patient. However, in order to provide further options, the arrangement shown in FIG. 3 is configured to use any one of three different types of patient characteristics in selecting previous patients.

A first set of characteristics employs the Clinical Picture Criteria (CPC), which is an available list of specific patient conditions or attributes which have been found to be main drivers of resource consumption. During the intake process, when incoming patient data is being acquired as described above, the specific CPC attributes can be checked for. Every CPC attribute that the incoming patient is found to have will be entered and recorded, and the entire set of such entered attributes will form or comprise the clinical picture for the incoming patient.

To select a group of similar previous patients, based on CPC, the circuit of FIG. 3 is provided with a processor 30, and also with a comparator 32 connected to both incoming patient database 18 and previous patient database 22. Processor 30 may be operated to load the clinical picture of the incoming patient into the comparator 32 from database 18. Clinical pictures of respective previous patients are then successively entered into comparator 32, for comparison with the incoming patient clinical picture. Previous patients found to have similar clinical pictures are then entered into the selected group. Clinical picture data stored in database 22 is represented in FIG. 3 at 22a.

The above procedure may identify few or no previous patients, if the CPC data or clinical picture of the incoming patient is so unique that the population of similar previous patients is small. If this occurs, the CPC criteria for the incoming patient could be changed, or a different characteristic could be used to determine the selected previous patient group.

An alternative selection characteristic used by the circuit of FIG. 3 is based on Diagnosis Related Group (DRG). DRG information for respective previous patients is represented in database 22 at 22b. In using this option, the DRG data for the incoming patient is loaded into comparator 32, and then compared with DRG data for successive previous patients to identify matches.

A third group selection characteristic (PHY) uses all of one particular physician's patients for the group. Information identifying previous patients by physician is shown to be stored in database 22 at 22c in FIG. 3.

Referring to FIG. 4, there is shown a flow chart directed to the rate monitor component for an embodiment of the invention. As indicated above, the rate monitor is designed to track the actual charges and costs incurred by every patient over a specified period of time. The rate monitor also tracks reimbursements.

As shown by function block 34 of FIG. 4, the first step in the operation of the rate monitor is to select a time period. Then, as indicated by block 36, the computer is directed to search for and select all patients that incurred charges during the period. Usefully, the system displays a list of all these charges. However, it may be desirable to limit the patients used to generate the charge information, such as to patients of specific financial classes or to combinations thereof. Thus, function block 38 by way of example indicates that a user of the rate monitor can select all patients listed for the time period, or can limit the list to commercial patients only or to Medicare patients only.

After a patient population has been selected, the user can acquire specific information for one or more of the selected patients, as illustrated by function block 40. For an individual patient the user can generate actual reimbursement, charges, costs and length of stay (LOS) information for the selected time period, and can also provide budget information for the patient. The charge and cost information can indicate daily charges and costs and other detailed information for each patient. For example, the rate monitor can provide the charges that a patient incurred for each department of the health care facility, on a daily basis.

FIG. 4 further shows function block 42, directed to editing patient-related parameters. For example, a user of the rate monitor could become aware that a patient's reimbursement had changed. The edit function enables the user to enter this change into the database, and to correspondingly adjust the reimbursement methodology for the patient.

Function block 44 of FIG. 4 is directed to generating management reports. The report generating function is useful for quickly providing information regarding a single patient, or cumulative information pertaining to a selected group of patients. In one embodiment, three different reports may be generated, respectively known as ‘Quick View,’ ‘Rate Monitor,’ and ‘Data Grid.’ The Quick View report displays all of a patient's costs and charges by department, with respect to the budget that was set up during pre-assessment. This report is broken down into two parts. The first part shows the entire stay to date, and the second part shows only the last seven days of the stay. This enables the user to monitor the overall stay together with recent changes that may have occurred in the previous seven days, and also to notice trends. The Rate Monitor report captures patient costs and charges by department, and then relates them to the reimbursement methodology. This provides a detailed report for each patient selected, as well as a summary for all selected patients that contain cumulative critical information. The Data Grid report enables downloading of information pertaining to daily charges, detailed charges, or daily costs for multiple patients. Each of these reports may be downloaded into, for example, a Microsoft Excel Spreadsheet format.

Referring to FIG. 5, there is shown a simplified computer system 46 for implementing embodiments of the invention, as described herein. System 46 includes a processor 48, which may be the same as or similar to processor 30 shown in FIG. 3, and further includes a computer readable medium 50 containing instructions that are readable by processor 48. Processor 48 is connected to operate a data storage device 52 and also a comparator 54 disposed to receive data from the storage device 52. Comparator 54 may be the same as or similar to comparator 32 shown in FIG. 3. Storage device 52 usefully includes incoming patient database 18 and previous patient database 22, referred to above, and also includes a rate monitor database 56. An output device 58 coupled to storage device 52 comprises a display, a printer or other device for providing data in viewable form.

In operation, computer readable medium 50 is furnished with instructions configured to cause processor 48 to operate in accordance with an embodiment of the invention. More particularly, processor 48 is operated to load incoming patient data, acquired for example, by means of intake coordinator terminal 10, into database 18 of storage device 52. Processor 48 then directs comparator 54 to compare data from the databases 18 and 22, in order to provide data for use by the processor in computing estimates of resources required for incoming patients, as described above. Processor 48 also continually updates database 56 with data indicating the health care resources actually used in providing services to respective patients. The processor may then operate storage device 52 and output device 58 to make such information available in real time, for use in adjustment or reallocation of subsequent resources delivered to patients. Output device 58 may also be used to provide management reports as referred to above.

The specific embodiments discussed here are merely illustrative and are not meant to limit the scope of the present invention in any manner. It should be appreciated that the present invention provides many applicable inventive concepts that may be embodied in a wide variety of specific contexts. For example, the present invention utilizes a software application that may operate on a wide variety of hardware configurations. These configurations range from single machine, single database installations to larger configurations made up of numerous machines and multiple databases. As a result, the present invention may be scaled up to meet added demand by increasing the number of machines to meet the number of users

Obviously, many other modifications and variations of the present invention are possible in light of the above teachings. It is therefore to be understood that within the scope of the disclosed concept, the invention may be practiced otherwise than as specifically described.

what is claimed is:

1. A management method for use by a health care provider engaged in furnishing services to patients, said method comprising the steps of:
acquiring a first set of data pertaining to a particular patient prior to furnishing health care services to said particular patient;
comparing data of said first set with data associated with respective prior patients of said health care provider in order to generate a second set of data associated with one or more selected prior patients;
computing from said second set of data an estimate of health care resources required to furnish specified services to said particular patient;
continually updating a database showing the resources actually used in providing services to respective patients of said health care provider including said particular patient; and
selectively accessing said database to provide real time data for use in allocating further health care resources to selected patients including said particular patient.

2. The method of claim 1 wherein:
said first set of data includes the clinical picture of said particular patient.

3. The method of claim 2 wherein:
said second set of data pertains to a group of said selected prior patients, each patient in said group having at least one characteristic which is similar to a characteristic of said particular patient.

4. The method of claim 1 wherein:
said real time data is provided in the form of a specified management report.

5. The method of claim 4 wherein:
said management report comprises a Quick View, Rate Monitor or Data Grid report, selectively.

6. The method of claim 1 wherein:
said real time data indicates the resources collectively used to furnish health care services to specified patients of said provider.

7. The method of claim 1 wherein:
said real time data indicates the health care resources actually used in providing health care services to patients during a specified time period.

8. The method of claim 1 wherein:
said method includes generating a budget for furnishing said specified services to said particular patient.

9. The method of claim 1 wherein:
said method includes providing a methodology for reimbursement for said specified services provided to said particular patient.

10. The method of claim 9 wherein:
said method includes determining whether said particular patient is included in a health care network having a contract with said health case provider, and if so accessing said contract for determining reimbursement for said specified services.

11. A computer system for use by a health care provider engaged in furnishing services to patients, said system comprising:
a first database containing a first set of data pertaining to a particular incoming patient;
a comparator disposed to compare data of said first set with data associated with prior patients of said health care provider in order to select one or more of said prior patients for a group;
a processor disposed to receive a second set of data associated with said group, and to use data of said second set to compute an estimate for health care resources required to furnish specified services to said particular patient; and
a rate monitor database which is continually updated to show the resources actually used in providing services to respective patients of said provider, said rate monitor database being selectively accessible to provide real time data for use in allocating further health care resources to selected patients.

12. The system of claim 11 wherein:
said first set of data includes the clinical picture of said particular patient.

13. The system of claim 11 wherein:
each previous patient selected for said group has at least one characteristic which is similar to a characteristic of said particular patient.

14. The system of claim 11 wherein:
said real time data indicates the resources actually used in furnishing health care services to specified patients during a specified period of time.

15. The system of claim 11 wherein:
said processor is operated to generate a budget for furnishing said specified services to said particular patient.

16. A computer system for use by a health care provider engaged in furnishing services to patients, said system comprising:
a processor; and
a computer readable medium connected to the processor, said computer readable medium including processor instructions configured to be read by said processor and thereby cause said processor to:
access a first set of data pertaining to a particular patient prior to furnishing health care services to said particular patient;
compare data of said first set with data associated with respective prior patients of said health care provider, in order to generate a second set of data associated with one or more selected prior patients;
compute from said second set of data an estimate of health care resources required to furnish specified services to said particular patient;
continually update a rate monitor database showing the resources actually used in providing services to respective patients of said health care provider including said particular patient; and
selectively access said rate monitor database to provide real time data for use in allocating further health care resources to selected patients including said particular patient.

17. The system of claim 16 wherein:
said first set of data includes the clinical picture of said particular patient.

18. The system of claim 17 wherein:
each selected previous patient has at least one characteristic which is similar to a characteristic of said particular patient.

19. The system of claim 16 wherein:
said real time data indicates the resources actually used in furnishing health care services to specified patients during a specified period of time.

20. The system of claim 16 wherein:
said processor is operated to generate a budget for furnishing said specified services to said particular patient.
